(19) United States
(12) Patent Application Publication
(10) Pub. No.: US 2014/0044892 A1
(43) Pub. Date: Feb. 13, 2014

(54) DISPLAY UNIT INCLUDING A SIMULATED FLYING INSECT

(71) Applicant: MATTHEW S. GLENN, SPRAGUE, NE (US)

(72) Inventor: MATTHEW S. GLENN, SPRAGUE, NE (US)

(21) Appl. No.: 13/584,190

(22) Filed: Aug. 13, 2012

(51) Int. Cl. A47G 7/00; A41G 1/00; A01G 9/02

(52) U.S. Cl. 428/16; 47/66.6

(57) ABSTRACT

A display unit including a flowerpot or the like having a plant arrangement therein and a simulated flying insect which is rotated around the flowerpot or the like.

### BACKGROUND OF THE INVENTION

1. Field of the Invention

This invention relates to a display unit and more particularly to a display unit including a flowerpot or the like having a plant arrangement therein and a simulated flying insect such as a butterfly, dragon fly, or the like which is rotated around the flowerpot.

2. Description of the Related Art

Many types of simulated butterflies have been previously provided. In one instance, a solar powered electric motor is incorporated into the butterfly to cause the wings of the butterfly to flap. It is believed by Applicant that such a butterfly is simply attached to a plant and does not rotate around the plant. In another prior art device, a simulated butterfly is attached to one end of a thin piano wire with the other end thereof being connected to an electric motor so that the butterfly is rotated around a stationary support. In this prior art device, the electric motor and the battery thereof is visible which detracts from the aesthetic appearance of the display.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A display unit is disclosed which includes a flowerpot or other stationary support having an open upper end and an electric motor positioned therein. The electric motor includes a driven shaft which is rotatable about a generally vertical axis. An elongated flexible wire, having inner and outer ends, is provided with the inner end of the flexible wire being operatively connected to the driven shaft so that the flexible wire extends upwardly and outwardly from the driven shaft and the flowerpot or support. A simulated flying insect such as a butterfly, dragon fly, etc. is operatively secured to the outer end of the flexible wire whereby the flying insect will rotate around the flowerpot or support when the driven shaft is rotated by the electric motor. An artificial arrangement, preferably a flowering plant is positioned in the flowerpot or support which at least partially hides the electric motor and components thereof from view.

In the preferred embodiment, the electric motor thereof is battery operated with the plant arrangement at least partially hiding the battery from view. In another embodiment, the electric motor is solar power driven. In the preferred embodiment, the plant arrangement is simulated but could be a live plant arrangement.

It is therefore a principal object of the invention to provide a display unit including a flowerpot having plants and or flowering plants therein with a flying insect such as a butterfly or dragonfly movably positioned outwardly of the flowerpot and including an electric motor which rotates the flying insect around the plants.

A further object of the invention is to provide a device of the type described wherein a plant arrangement in the flowerpot substantially hides the components of the apparatus for driving the flying insect around the flowerpot.

A further object of the invention is to provide a display unit of the type described which is aesthetically pleasing.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the display unit of this invention;

FIG. 2 is a side view of the display unit of this invention;

FIG. 3 is an exploded perspective view of the flying insect and the mechanism for rotating the flying insect around the plant arrangement;

FIG. 4 is a sectional view of the flowerpot of FIG. 1 and the associated structure which rotates the flying insect around the flowerpot;

FIG. 5 is a schematic of the circuitry of the invention wherein the motor is battery driven; and

FIG. 6 is a schematic which illustrates that the motor of the invention is driven by a solar panel.

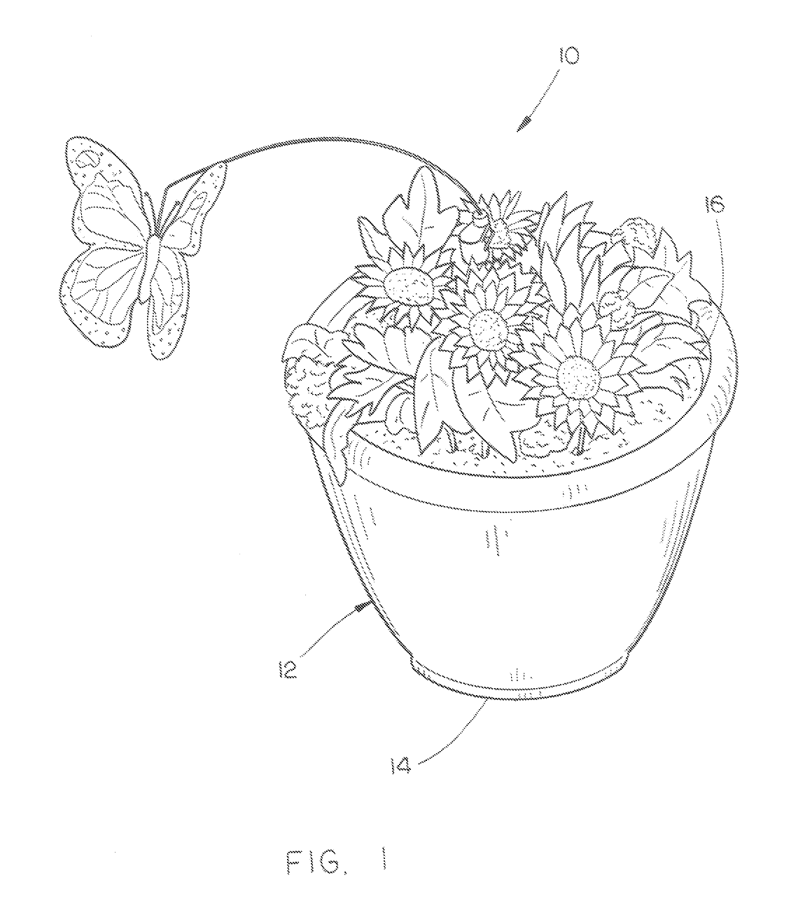

### DESCRIPTION OF THE PREFERRED EMBODIMENT

Embodiments are described more fully below with reference to the accompanying figures which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The display unit of this invention is referred to by the reference numeral 10. Display unit 10 includes a base unit or stationary unit such as a flowerpot 12, having a base 14 and an open upper end 16. Although the preferred base unit 14 is a flowerpot, the base unit could be any type of container or support which may have a simulated flower or plant arrangement 18 positioned therein or thereon. The plant arrangement could be a live plant as well. Plant arrangement 18 includes a ring-shaped body member 20 having a plurality of flowers, leaves, berries, etc. 22 extending upwardly therefrom to substantially cover the open upper end 16 of the flowerpot 12.

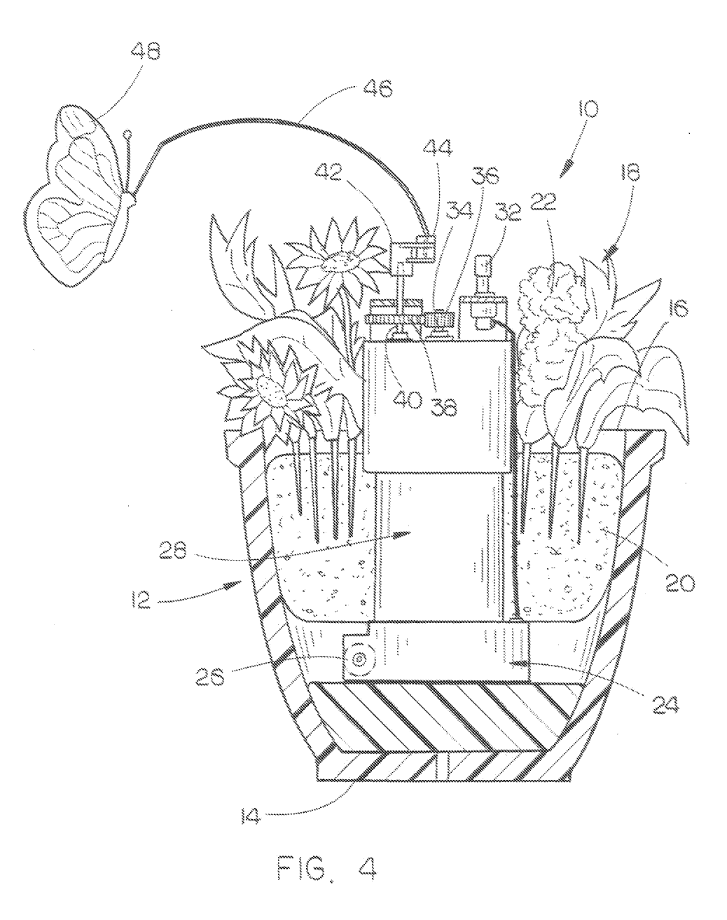

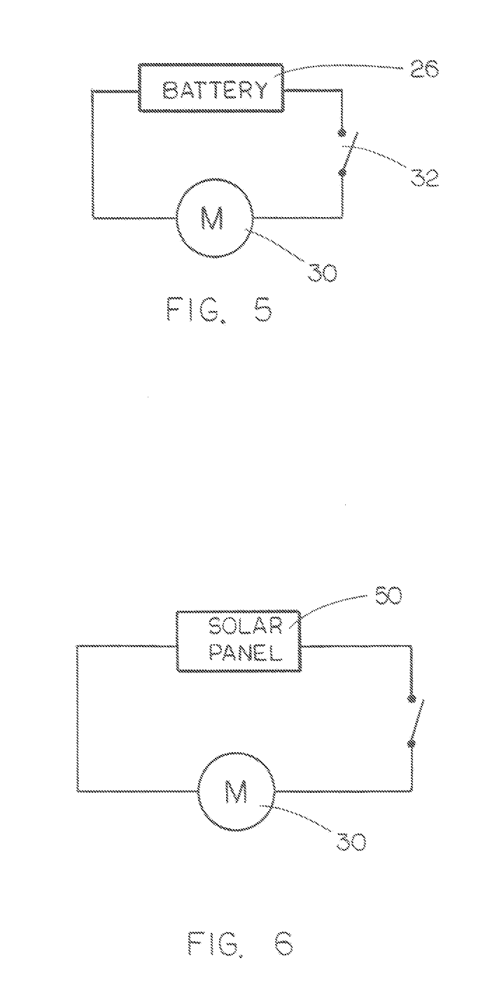

The numeral 24 refers to a battery housing or support which has a battery 26 selectively removably secured thereto. A tubular housing 28 extends upwardly from battery housing 24 and which has a small DC electric motor 30 mounted therein which is electrically connected to the battery 30. As seen in FIGS. 4 and 5, a switch 32 is provided in the electrical circuitry between battery 26 and motor 30 to provide a means for starting and stopping the motor 30.

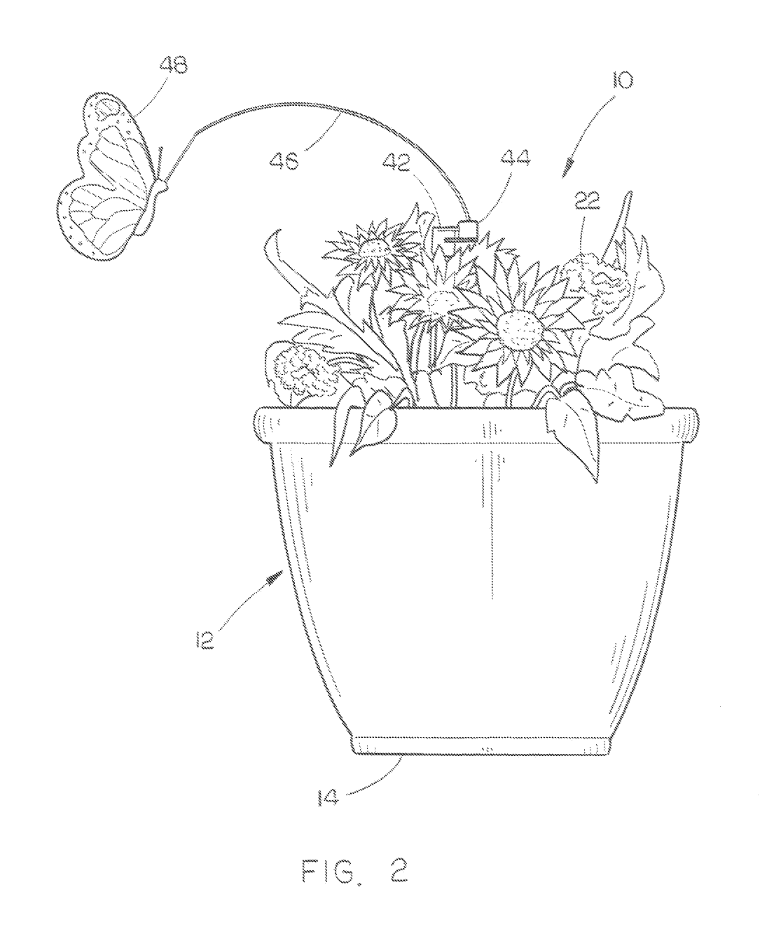

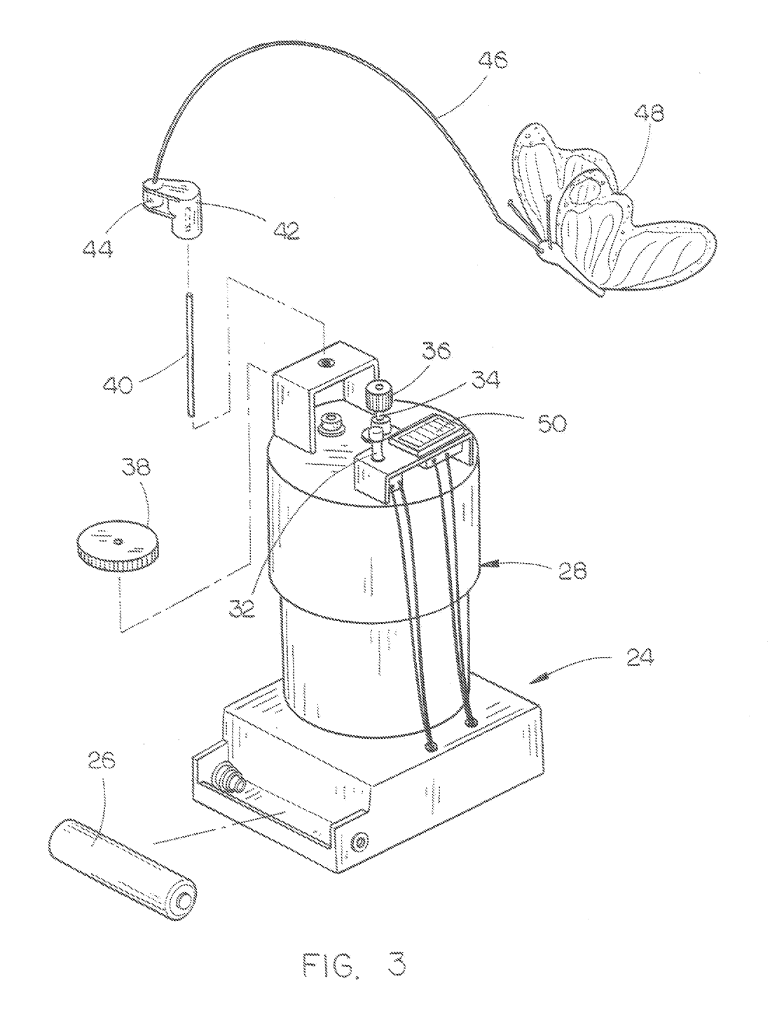

Motor 30 has a rotatable power shaft 34 extending upwardly therefrom which has a gear 36 secured thereto. Gear 36 is in mesh with a gear 38 which is affixed to a vertically disposed and rotatable shaft 40 whereby rotation of gear 38 by the gear 36 will cause rotation of the shaft 40. A cylindrical cap-like member 42 is secured to the upper end of shaft 40 for rotation therewith. A wire support member 44 is secured to member 42 at one side thereof as seen in FIGS. 2, 3 and 4. The inner end of a flexible wire 46, such as a piano wire, is secured to support member 44 as also seen in FIGS. 2, 3 and 4. A simulated flying insect 48, such as a butterfly, dragonfly, etc., is attached to the outer end of wire 46 as seen in FIGS. 2, 3 and 4.

When motor 30 is energized, the power shaft 32 rotates gear 34 which rotates gear 36 which rotates shaft 40 to cause the wire 46 and the simulated insect 48 thereon to be rotated around the flowerpot 12 and the plant arrangement 18. The flexible wire, as it rotates around the flowerpot, causes the insect 48 to bounce up and down and flap its wings as if it was going to land on the plant arrangement 18.

The plant arrangement 18 substantially covers the gears 38 and 36, the upper end of housing 28 and the other components of the device to enhance the aesthetic appearance of the display unit. The unit 10 may be used indoors or outdoors. If the unit is going to be used outdoors, a solar panel 50 may be used to drive the motor 30, as seen in FIG. 6, in conventional fashion.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A display unit, comprising:
a flowerpot having an open upper end;
an electric motor positioned in said flowerpot;
said electric motor including a driven shaft which is rotatable about a generally vertical axis;
an elongated flexible wire having inner and outer ends;
said inner end of said flexible wire being operatively connected to said driven shaft so that said flexible wire extends upwardly and outwardly from said driven shaft and said flowerpot;
a simulated flying insect operatively secured to said outer end of said flexible wire whereby said flying insect will rotate around said flowerpot when said driven shaft is rotated by said electric motor;
and a plant arrangement positioned in said flowerpot which at least partially hides said electric motor from view.

2. play unit of claim 1 wherein said electric motor is battery operated and wherein said plant arrangement also at least partially hides the battery from view.

3. The display unit of claim 1 wherein said electric motor is solar power driven.

4. The display unit of claim 1 wherein said plant arrangement s a simulated plant.

5. display unit of claim 1 wherein said plant arrangement completely hides said electric motor from view.

6. The display unit of claim 2 wherein said plant arrangement completely hides said electric motor and the battery from view.

7. The display unit of claim 1 wherein said simulated flying insect is a butterfly.

8. display unit of claim 1 wherein said simulated flying insect is a dragonfly.

9. The display unit of claim 1 wherein said plant arrangement is an artificial plant.

10. The display unit of claim 1 wherein said plant arrangement includes flowering plants.

11. A display unit, comprising:
a plant support having an open upper end;
an electric motor positioned in said plant support;
said electric motor including a driven shaft which is rotatable about a generally vertical axis;
an elongated flexible wire having inner and outer ends;
said inner end of said flexible wire being operatively connected to said driven shaft so that said flexible wire extends upwardly and outwardly from said driven shaft and said plant support;
a simulated flying insect operatively secured to said outer end of said flexible wire whereby said flying insect will rotate around said plant support when said driven shaft is rotated by said electric motor;
and a plant arrangement positioned in said plant support which at least partially hides said electric motor from view.

12. The display unit of claim 11 wherein said electric motor is battery operated and wherein said plant arrangement also at least partially hides the battery from view.

13. The display unit of claim 11 wherein said electric motor is solar power driven.

14. The display unit of claim 11 wherein said plant arrangement is a simulated plant.

15. The display unit of claim 11 wherein said plant arrangement completely hides said electric motor from view.

16. The display unit of claim 11 wherein said plant arrangement completely hides said electric motor and the battery from view.

17. The display unit of claim 11 wherein said simulated flying insect is a butterfly.

18. The display unit of claim 11 wherein said simulated flying insect is a dragonfly.

19. The display unit of claim 19 wherein said plant arrangement is an artificial plant.

20. The display unit of claim 11 wherein said plant arrangement includes flowering plants.
